(19) United States
(12) Patent Application Publication
(10) Pub. No.: US 2005/0221824 A1
(43) Pub. Date: Oct. 6, 2005

(54) Method for handover between different type MMMB systems

(76) Inventors: Jae-Hwan Lee, Seongnam-si (KR); Ki-Ho Cho, Seongnam-si (KR); Dong-Hee Lee, Ansan-si (KR); Hwa-Jin Cha, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/069,050

(22) Filed: Mar. 2, 2005

(30) Foreign Application Priority Data
Mar. 2, 2004 (KR) 2004-14127
Mar. 2, 2004 (KR) 2004-14128

(51) Int. Cl. H04Q 7/20

(52) U.S. Cl. 455/435.2; 455/422.1

(57) ABSTRACT

Disclosed is a method for controlling activation/deactivation of two kinds of operation modes of an MMMB mobile terminal during handover between different types of systems. To control the activation/deactivation, a system controller instructs the mobile terminal to activate/deactivate the operation modes or provides activation/deactivation conditions to the mobile terminal. In particular, when the mobile terminal in communication is situated in a border cell neighboring a target system, the mobile terminal activates target system-related modules and then performs handover into the target system according to predetermined conditions after the passage of a predetermined time period. Such a handover method minimizes time required for performing handover, prevents deterioration of call quality during the handover, and saves power consumption of the mobile terminal.

### BACKGROUND OF THE INVENTION

1. Field of the Invention

The present invention relates to a handover technology of a mobile communication system, and more particularly to a handover method between different types of systems.

2. Description of the Related Art

The 3^{rd} generation (3G) mobile communication system, which is also called International Mobile Technology (IMT) 2000, uses a Code Division Multiple Access (CDMA) technology and consistently provides a service capable of transmitting at high speed of at least 2 Mbps a packet-based text, digitalized voice, video or multimedia data, regardless of the global location of users of mobile phones or terminals using the service. The 3G mobile communication system can be divided into the Wideband CDMA (WCDMA) communication system and the CDMA-2000 communication system. The WCDMA communication system employs an asynchronous scheme and has been adopted as a European standard, while the CDMA-2000 communication system employs a synchronous scheme and has been adopted as an American standard.

The WCDMA communication system is also called Universal Mobile Telecommunication Service (UMTS) system and is based on the Global System for Mobile Communications (GSM) and the General Packet Radio Services (GPRS), which are widely used in Europe and other regions. The CDMA-2000 communication system is based on the 2^{nd} generation (2G) CDMA system such as IS-95 or J-STD008, which have been used in Republic of Korea, United States, Japan, etc. Currently, harmonization between the two types of systems is being pursued, so various technologies for compatibility between the two types of systems are being researched and developed. The major one of them is a technology for handover which may occur when a mobile terminal (which is also called a ‘Mobile Station (MS)’ or a ‘User Equipment (UE)’) moves between the two different types of systems.

Handover is a technology for enabling a mobile terminal to continue communication without interruption while moving from one cell to another cell in a cellular mobile communication system. Handover is divided into two types, including soft handover and hard handover. According to the soft handover, communication is performed through multiple channels in an overlapping zone among two or more cells, and one of the multiple channels is dropped when quality of the channel is degraded below a reference value. According to the hard channel, when a mobile terminal moves between cells, the mobile terminal drops the channel of a previous cell and tries connection to the neighbor cell which the mobile terminal enters.

Hard handover occurs when a Multi-Mode and Multi-Band (MMMB) mobile terminal capable of communicating with both asynchronous and synchronous mobile communication systems moves from the asynchronous mobile communication system to the synchronous mobile communication system. This is because it is impossible for the mobile terminal to simultaneously connect with channels of the two different types of communication systems. The mobile terminal in communication measures information about neighbor cells and reports it to a base station, when a received pilot signal has a magnitude below a reference value or at the request of the base station. Such measurement of the information about neighbor cells as described above is referred to as ‘cell searching’. The measured and reported information is used as judgment information about handover occurring when the mobile terminal moves to another cell while performing communication.

An instruction for handover during communication is transmitted to a mobile terminal through a traffic channel in a case of the synchronous mobile communication system and through a dedicated channel in a case of the asynchronous mobile communication system. When a mobile terminal has received an instruction for handover into a different type of system, the mobile terminal shifts to a different kind of Radio Access Technology (RAT) mode, notifies the target system of handover completion, and performs hard handover, thereby maintaining the communication. In this scheme, if it takes the mobile terminal more than several seconds to shift to the different kind of RAT mode, it takes too long a time to perform the handover and the time till which the target system waits for receiving the handover completion message expires, so that the mobile terminal may fail in the handover.

The MMMB mobile terminal uses the RAT mode for access to different types of systems. That is, the MMMB mobile terminal moving between cells of a WCDMA system and a CDMA system has a WCDMA mode and a CDMA mode, and shifts between the modes according to the RAT of the system to which the mobile terminal is going to access. For the handover, the mobile terminal searches all accessible different types of RAT systems. This means that the mobile terminal frequently experiences the shift between the RAT modes. However, if handover does not occur despite that all communication modules of two different kinds of modes are activated, power consumption unnecessarily increases due to the simultaneous activation of the two modes.

It is ideal that there is no time delay in the MMMB mobile terminal's shift to the RAT mode during the handover between different types of systems. However, for a typical MMMB mobile terminal, activation of the CDMA mode is delayed for at least 10 seconds. The activation of the CDMA mode includes enabling of CDMA-related modems, CDMA pilot signal search, sync message reception, and CDMA synchronization. In contrast, it takes a similar length of time to activate the WCDMA mode.

When the MMMB mobile terminal performs the handover by activating an RAT mode of another system after having determined to perform the handover, the handover is excessively extended due to the inter-mode time delay as described above. If it takes too long a time to perform the handover, the signal from the system in service may be degraded causing problems in the communication quality, such as call interruption, even before the handover is completed or the handover target system may fail to receive the handover completion message from the mobile terminal within a predetermined time period, resulting in failure of the handover.

In order to solve this problem, the MMMB mobile terminal may activate an RAT mode of another system having potential of handover in advance before actually performing the handover. However, such a solution may unnecessarily increase power consumption of the mobile terminal unless conditions for the handover are satisfied in a state where the two types of RAT modes are simultaneously activated.

### SUMMARY OF THE INVENTION

Accordingly, the present invention has been made to solve the above-mentioned problems occurring in the prior art, and an object of the present invention is to provide a method for controlling different kinds of operation modes of an asynchronous mobile communication system and a synchronous mobile communication system by an MMMB mobile terminal.

It is another object of the present invention to provide a method for controlling activation/deactivation of operation modes of a mobile terminal during handover between an asynchronous mobile communication system and a synchronous mobile communication system in the systems.

It is yet another object of the present invention to provide a method for performing handover between different types of systems according to judgment of a system controller when a mobile terminal cannot judge a system for which handover is performed.

To accomplish these objects, in accordance with an embodiment of a first aspect of the present invention, there is provided a method for controlling a system mode of an MMMB mobile terminal, which is capable of access to a source system and a target system employing different wireless access technologies from each other, in order to perform hard handover between different types of systems employing the different wireless access technologies from each other, the method comprising the steps of: judging whether or not activation conditions of a target system mode related to the target system are satisfied with respect to the mobile terminal in communication with the source system; transmitting an activation instruction message instructing activation of the target system mode to the mobile terminal if the activation conditions are satisfied; and performing the mobile terminal's handover into the target system if the handover into the target system is determined after the transmission of the activation instruction message.

In accordance with an embodiment of a second aspect of the present invention, there is provided a method for controlling a system mode of an MMMB mobile terminal, which is capable of access to a source system and a target system employing different wireless access technologies from each other, in order to perform hard handover between different types of systems employing the different wireless access technologies from each other, the method comprising the steps of: receiving an activation instruction message instructing activation of a target system mode related to the target system from the source system in communication with the mobile terminal; activating the target system mode to search the target system in response to the activation instruction message; and

performing handover into the target system if the handover into the target system is instructed from the source system.

In accordance with another embodiment of the first aspect of the present invention, there is provided a method for controlling a system mode of an MMMB mobile terminal, which is capable of access to a source system and a target system employing different wireless access technologies from each other, in order to perform hard handover between different types of systems employing the different wireless access technologies from each other, the method comprising the steps of: transmitting an activation/deactivation control message including activation or deactivation conditions of a target system mode related to the target system to the mobile terminal in communication with the source system; receiving an activation event report notifying that the target system mode has been activated from the mobile terminal; and performing the mobile terminal's handover into the target system if the handover into the target system is determined after the reception of the activation event report.

In accordance with another embodiment of the second aspect of the present invention, there is provided a method for controlling a system mode in order to perform hard handover between different types of systems employing different wireless access technologies from each other in an MMMB mobile terminal capable of access to a source system and a target system employing the different wireless access technologies from each other, the method comprising the steps of: receiving an activation/deactivation control message including activation or deactivation conditions of a target system mode related to the target system from the source system in communication with the mobile terminal; measuring at least one of a signal from the source system and a signal from the target system to judge whether or not the activation or deactivation conditions are satisfied; activating the target system mode so as to search the target system if the activation conditions are satisfied as a result of the judgment; and performing handover into the target system if the handover into the target system is instructed from the source system.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view showing a configuration of a cellular mobile communication network to which the present invention is applied;

FIG. 2 is a schematic view showing an overlay structure between different types of systems to which the present invention is applied;

FIG. 3 is a schematic block diagram showing a structure of an MMMB mobile terminal for both the WCDMA and the CDMA to which the present invention is applied;

FIG. 4 is a message flowchart showing a typical handover process between different types of systems;

FIG. 5 is a message flowchart showing a handover process between different types of systems in accordance with a preferred embodiment of the present invention;

FIG. 6 is a message flowchart showing a process for controlling activation/deactivation of a different kind of mode in accordance with a first embodiment of the present invention;

FIG. 7 is a message flowchart showing a process for controlling activation/deactivation of a different kind of mode in accordance with a second embodiment of the present invention;

FIG. 8 is a schematic view showing an example of network structures of a WCDMA system and a CDMA system which can be applied to the present invention;

FIG. 9 is a schematic view for explaining a handover process between different types of systems in accordance with a first embodiment of the present invention;

FIG. 10 is a message flowchart showing a handover process between different types of systems by using information about a border cell in accordance with the first embodiment of the present invention;

FIG. 11 is a schematic view for explaining a handover process between different types of systems in accordance with a second embodiment of the present invention;

FIG. 12 is a message flowchart showing a handover process between different types of systems by using a signal from a dummy cell in accordance with the second embodiment of the present invention; and

FIG. 13 is a schematic view for explaining a handover process into a different type of system in a handover state between system controllers in accordance with another preferred embodiment of the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear. Further, various specific definitions found in the following description are provided only to help general understanding of the present invention, and it is apparent to those skilled in the art that the present invention can be implemented without such definitions.

In preferred embodiments of the present invention to be described below, handover between different types of systems is performed after a different kind of RAT mode of an MMMB mobile terminal is activated, and a system controller of a serving system controls activation of the different kind of RAT mode to synchronize judgment on the activation of the RAT mode between the system and the mobile terminal. That is, for the handover between different types of systems, the serving system instructs the mobile terminal to activate the different kind of RAT mode in advance, and determines to perform the handover after the predicted time required for the activation has passed, thereby minimizing the time taken to perform the handover.

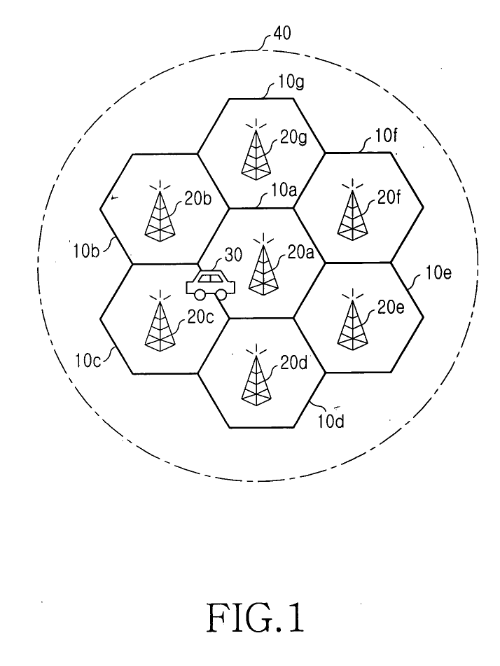

FIG. 1 illustrates a configuration of a cellular mobile communication network to which the present invention is applied.

Referring to FIG. 1, the entire service area of the mobile communication network 40 is divided into a plurality of cells 10a through 10g neighboring each other. Although the cells 10a through 10g have a hexagonal shape, respectively in FIG. 1, each cell actually has an irregular shape according to the intensity of the electric wave and the locations of obstacles. Further, most of the cells partly overlay other neighbor cells. The cells 10a through 10g belong to corresponding base stations 20a through 20g, respectively, each of which provides a communication service to a mobile terminal 30 through a traffic channel and a control channel.

Although not dividedly shown, the base stations 20a through 20g can be divided into those of asynchronous mobile communication systems and those of synchronous mobile communication systems according to the upper layer network elements connected to the base stations and the radio transmission scheme supported by the base stations. Each of the base stations 20a through 20g is called ‘Base Transceiver Subsystem (BTS)’ in the CDMA mobile communication system and ‘Node B’ in the WCDMA mobile communication system. However, as used herein, it will be referred to as ‘base station’ for both CDMA mobile communication system and the WCDMA mobile communication system. Here, handover between systems occurs when the mobile terminal 30 moves in an overlay zone between the cells under the control of the base stations belonging to different types of systems.

Although not shown, each of the base stations 20a through 20g is connected to a Mobile Switching Center (MSC) and a Core Network (CN) through a network element called ‘Base Station Controller (BSC)’ in the CDMA system and ‘Radio Network Controller (RNC)’ in the WCDMA system. The BSC and the RNC determine handover of a mobile terminal moving between cells. The BSC and the RNC, which will be hereinafter referred to as the ‘BSC’ in common, determine communication and handover of a mobile terminal moving between cells and control the RAT mode.

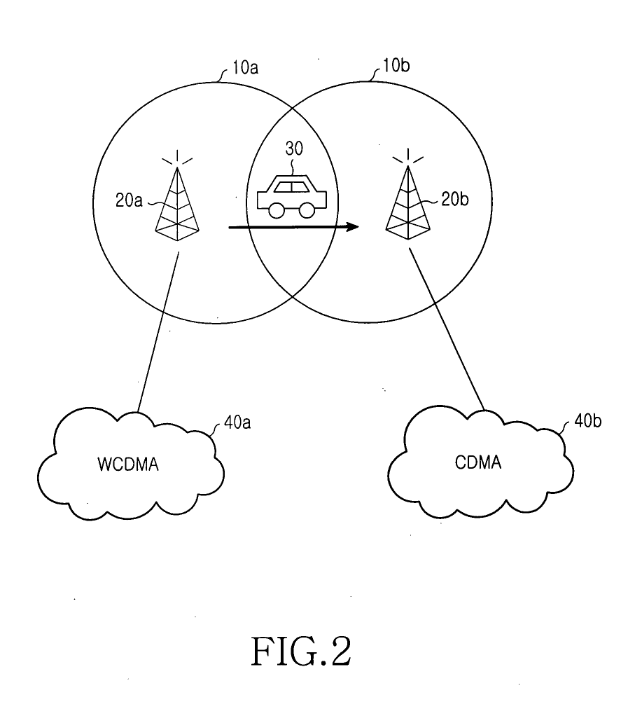

FIG. 2 illustrates an overlay structure between different types of systems to which the present invention is applied.

In FIG. 2, the mobile terminal 30 is moving toward a second cell 10b in an overlay zone between a first cell 10a belonging to an asynchronous base station 20a and the second cell 10b belonging to a synchronous base station 20b. The asynchronous base station 20a is connected to a WCDMA network 40a which is also usually called ‘UMTS’ in the 3^{rd} Generation Partnership Project (3GPP) standard. The synchronous base station 20b is connected to a CDMA network 40b of the 3GPP2 standard. The cells 10a and 10b are commonly used as the same meaning as the corresponding base stations 20a and 20b.

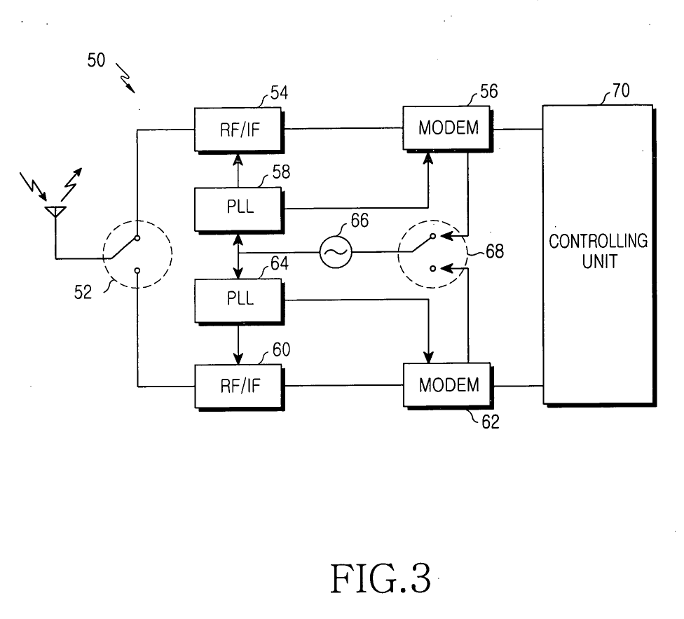

The mobile terminal 30 is an MMMB mobile terminal supporting an asynchronous (WCDMA) mode of the 3GPP standard and a synchronous (CDMA) mode of the 3GPP2 standard. FIG. 3 is a schematic block diagram of an MMMB mobile terminal for both the WCDMA mode and the CDMA mode in accordance with a preferred embodiment of the present invention.

Referring to FIG. 3, the MMMB mobile terminal includes Radio Frequency/Intermediate Frequency (RF/IF) units 54 and 60, Phase Locked Loop (PLL) units 54 and 60, and modems 56 and 62, for processing WCDMA signals and CDMA signals, respectively. In the MMMB mobile terminal, the elements for processing WCDMA signals and the elements for processing CDMA signals share a controller 70, an oscillator 66 and antenna, and are constructed such that they can be selected by first and second switches 52 and 68 according to the RAT operation modes.

When the MMMB mobile terminal operates in the asynchronous (WCDMA) mode, the first and second switches 52 and 68 are connected to the side of the WCDMA modules 54, 56 and 58. In contrast, when the MMMB mobile terminal operates in the synchronous (CDMA) mode, the first and second switches 52 and 68 are connected to the side of the CDMA modules 60, 62 and 64.

FIGS. 1 through 3 show only an example of the structures of a network having different types of systems and the MMMB mobile terminal, by which the present invention should not be limited. For example, the MMMB mobile terminal may share the RF/IF unit while the modems are separately constructed according to the operation modes. As used herein, it should be understood that a mobile terminal signifies an MMMB mobile terminal throughout the specification unless there is a peculiar comment thereon.

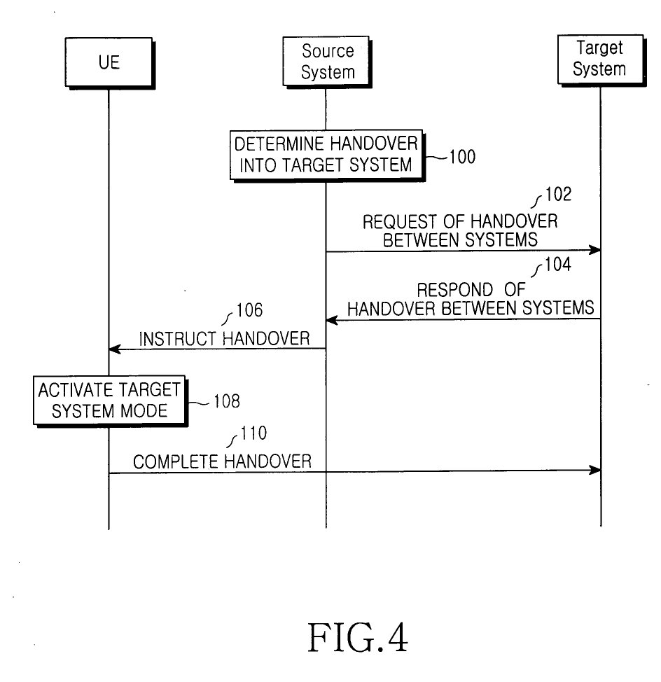

FIG. 4 illustrates a typical handover process between different types of systems. Here are shown operations for handover of a UE consisting of an MMMB mobile terminal from a source system into a target system.

Referring to FIG. 4, the mobile terminal is being in communication with the source system, and periodically measures the intensities of signals from neighbor cells to report them to the source system. Based upon the report, the source system, in particular, the BSC or the RNC of the source system then determines that the mobile terminal performs handover between different types of systems, that is, handover into the target system (step 100), and requests the handover between the systems to the target system to which the mobile terminal is going to move (step 102). If a response to the request of the handover between the systems is received from the target system (step 104), the source system instructs the mobile terminal to perform the handover (step 106). The mobile terminal deactivates the RAT mode of the source system and activates the RAT mode of the target system to perform shift between the modes, and then attempts access to the target system (step 108). If the mobile terminal succeeds in access to the target system, it reports handover completion to the target system (step 110).

However, in the handover process as described with reference to FIG. 4, it takes much time to perform the shift between the modes in step 108. Therefore, in a preferred embodiment of the present invention, the source system instructs the mobile terminal to activate the RAT mode of the target system before it determines on handover.

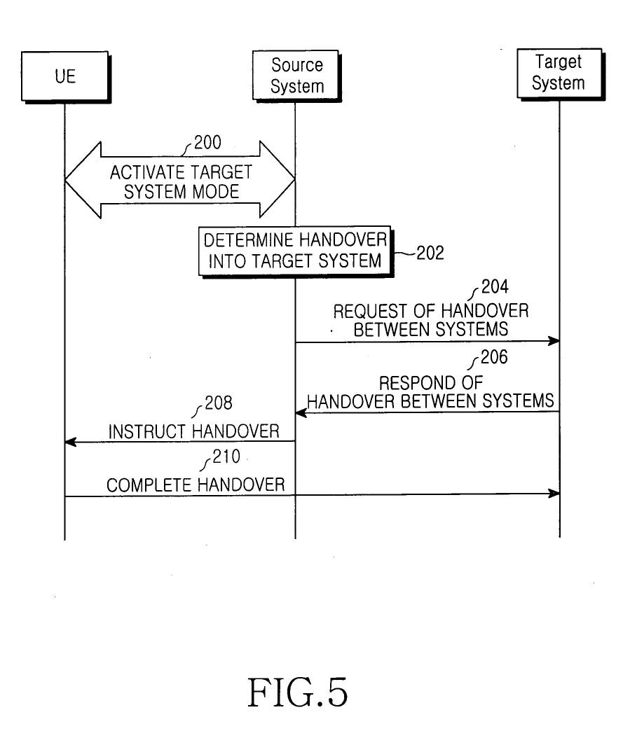

FIG. 5 illustrates a handover process between different types of systems in accordance with such a preferred embodiment of the present invention. Referring to FIG. 5, the source system instructs the mobile terminal to activate the RAT mode of the target system regardless of its determination on handover (step 200). If the source system determines that handover into the target system is performed (step 202), it requests the handover between the systems to the target system to which the mobile terminal is going to move (step 204). If a response to the request of the handover between the systems is received from the target system (step 206), the source system instructs the mobile terminal to perform the handover (step 208). Then, the mobile terminal immediately attempts access to the target system without performing shift between different kinds of modes because the RAT mode of the target system has been already activated. If the mobile terminal succeeds in access to the target system, it reports handover completion to the target system (step 210).

1. Activation/Deactivation

As described above, the source system instructs the mobile terminal to activate a different kind of mode in step 200. With respect to this, the present invention proposes two embodiments. In one embodiment, the source system directly instructs the mobile terminal to activate or deactivate a different kind of mode. In the other embodiment, the source system provides conditions for activation/deactivation of a different kind of mode to the mobile terminal, and if the conditions are satisfied, the mobile terminal performs the activation or deactivation of a different kind of mode and then reports the result of the activation/deactivation to the source system.

Hereinafter, these two embodiments will be dividedly described.

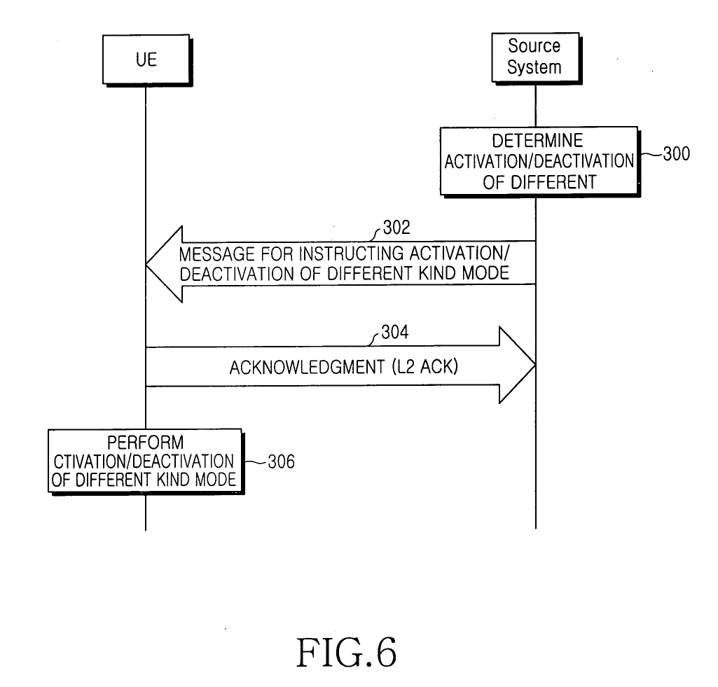

FIG. 6 illustrates a message flowchart showing a process for controlling activation/deactivation of a different kind of mode in accordance with the former of the two embodiments of the present invention.

Referring to FIG. 6, a source system controller, that is, a RNC in the WCDMA system or a BSC in the CDMA system determines that a mobile terminal currently in communication with the source system activates or deactivates a different kind of mode. A concrete example of activating or deactivating a different kind of mode will be described later. If the activation or deactivation has been determined, the source system controller transmits a message for instructing activation or deactivation of a different kind of mode to the mobile terminal (step 302). Such an instruction message clarifies a target system to be activated or deactivated. The mobile terminal transmits a Layer 2 response (L2 acknowledge) to the source system and activates or deactivates the relevant different kind of mode.

A configuration of the message for instructing activation/deactivation of a different kind of mode is shown below in Table 1.

TABLE 1

| Information | | |
|---|---|---|
| Element/Group name | Need | Description |
| Other RAT Identity | MP | 0: GSM, 1: cdma2000, 2: WCDMA, . . . |
| | | etc. |
| Activation | MP | 0: deactivate, 1: activate |

Here, ‘MP’ signifies ‘Mandatory Present’.

As shown in Table 1, the message for instructing activation/deactivation of a different kind of mode includes field ‘Other RAT Identity’ and field ‘Activation’. The source system controller clarifies a target system to be activated or deactivated in field ‘Other RAT Identity’ of the instruction message. Whether the source system controller instructs activation or deactivation is clarified in field ‘Activation’.

When a WCDMA system controller (that is, RNC) intends a mobile terminal in communication with a WCDMA system to perform handover into a CDMA system, it transmits a message for instructing activation of a different kind of mode to the mobile terminal. At this time, field ‘Other RAT Identity’ of the message for instructing activation of a different kind of mode is set to ‘cdma2000’ and field ‘Activation’ is set to ‘activate’ (‘1’). The mobile terminal in communication with the WCDMA system transmits an acknowledgment to the WCDMA system controller pursuant to the instruction message, and then enables a CDMA modem to perform a CDMA cell searching process.

When the WCDMA system controller intends the mobile terminal activated into the CDMA mode to cancel the handover into the CDMA system, it transmits a message for instructing deactivation of a different kind of mode to the mobile terminal. At this time, field ‘Other RAT Identity’ of the message for instructing deactivation of a different kind of mode is set to ‘cdma2000’ and field ‘Activation’ is set to ‘deactivate’ (‘0’). The mobile terminal, which is progressing or has completed the CDMA mode activation, disenables the CDMA modem and transmit an acknowledgment to the RNC in response to the instruction message. Thereafter, the mobile terminal operates only in the CDMA mode.

The WCDMA system controller does not progress the handover into the CDMA system until a predetermined time T1 passes after instructing the activation of the CDMA mode. The predetermined time T1 is a time which is predicted to be required for the mobile terminal to activate the CDMA mode and acquire sync of the CDMA system, and is determined by actual measurement. For example, the time T1 is about 10 seconds. After the time T1 has passed, the WCDMA system controller determines whether or not the handover into the CDMA system is performed. If the WCDMA system controller intends not to progress the handover into the CDMA system any more, it deactivates the CDMA mode of the mobile terminal by transmitting the message for instructing activation/deactivation of a different kind of mode while setting field ‘Activation’ to ‘deactivate’ (‘0’).

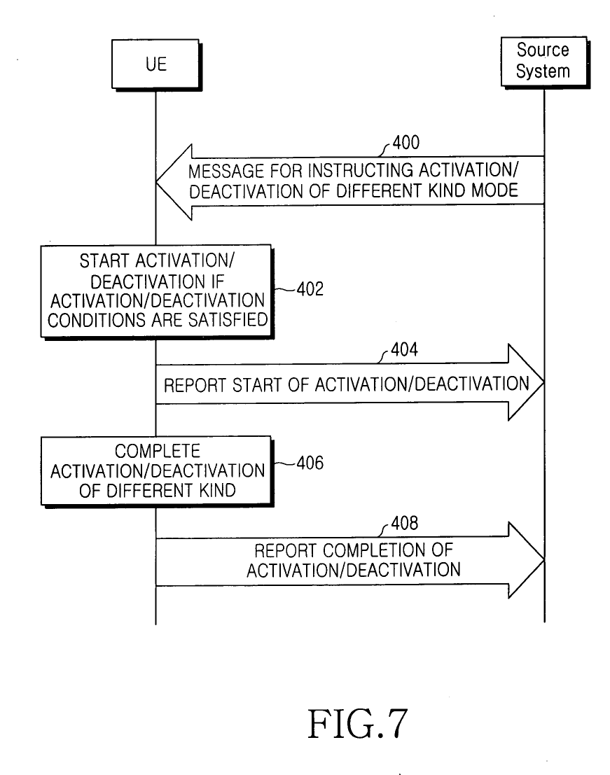

FIG. 7 illustrates a message flowchart showing a process for controlling activation/deactivation of a different kind of mode in accordance with the latter of the above-mentioned two embodiment of the present invention.

Referring to FIG. 7, a source system controller, that is, a RNC in the WCDMA system or a BSC in the CDMA system previously provides conditions for activation/deactivation of a different kind of mode to a mobile terminal (UE) currently in communication with the source system using a message for controlling activation or deactivation of a different kind of mode (step 400). The mobile terminal judges the activation/deactivation conditions with reference to a signal from a source system and a signal from a target system (step 402). Here, if a Received Signal Strength Indicator (RSSI) is used as the signal from a target system in judging the activation/deactivation conditions, the mobile terminal can measure the signal from a target system without activating modules related to the target system.

When the mobile terminal judges that the activation or deactivation is needed, it starts to perform shift between modes while reporting the start of the activation/deactivation to the source system (step 404). Here, step 404 may be omitted according to the choice of a system designer. If the shift between modes is completed (step 406), the mobile terminal reports the activation/deactivation completion to the source system (step 408).

A configuration of the message for controlling activation/deactivation of a different kind of mode is shown below in Table 2.

TABLE 2

| Information | | | |
|---|---|---|---|
| Element/Group | | | |
| name | Need | Multi | Description |
| Other RAT Identity | MP | | 0: GSM, 1: cdma2000, 2: WCDMA, |
| | | | . . . etc. |
| Reporting Time | OP | | 0: start, 1: complete, |
| | | | 2: start and complete |
| Event Identity | MP | 2 | 0: deactivate, 1: activate |
| ≧Own System | OP | | 0: greater than threshold |
| Criteria | | | 1: smaller than threshold |
| ≧Own System | OP | | when Measurement Quantity is RSSI, |
| Threshold | | | RSCP →dBm |
| | | | when Measurement Quantity |
| | | | is Ec/No → dB |
| ≧Other System | OP | | dBm |
| Threshold | | | |
| ≧Time to Trigger | MP | | Ms |
| ≧Own System | OP | | 0: RSSI, 1: CPICH EcNo, |
| Measurement | | | 2: CPICH RSCP, 3: Path-Loss |
| Quantity | | | |
| ≧Other System | OP | | 0: RSSI |
| Measurement | | | |
| Quantity | | | |
| ≧Measured Cell | OP | 0˜32 | cell list to be measured |

Here, ‘OP’ signifies ‘Optional Present’.

Hereinafter, a description will be given for each field of the message for controlling activation/deactivation of a different kind of mode.

Field ‘Other RAT Identity’ designates a type of a different system to be activated or deactivated. For example, ‘0’ designates the GSM, ‘1’ designates the CDMA2000 and ‘2’ designates the WCDMA.

Field ‘Reporting Time’ designates a point of time when a mobile terminal must report an activation/deactivation event. ‘start’ (‘0’) represents that a mobile terminal must report the activation/deactivation event at the start of activation/deactivation, ‘complete’ (‘1’) represents that a mobile terminal must report the activation/deactivation event at the completion of activation/deactivation, and ‘start and complete’ (‘2’) represents that a mobile terminal must report the activation/deactivation event at both the start and completion of activation/deactivation.

Field ‘Event Identity’ indicates whether the different kind of mode designated by field ‘Other RAT Identity’ is to be activated or deactivated. ‘Deactivate’ (‘0’) represents that the different kind of mode designated by field ‘Other RAT Identity’ is to be deactivated, and ‘Activate’ (‘1’) represents that the different kind of mode designated by field ‘Other RAT Identity’ is to be activated. There may be one or two field(s) ‘Event Identity’, for which subfields indicated by mark ‘>’ exist, respectively. The subfields following field ‘Event Identity’ having a value of ‘0’ represents deactivation conditions and the subfields following field ‘Event Identity’ having a value of ‘1’ represents activation conditions.

Field ‘Own System Criteria’ is used in a case where field ‘Own System Threshold’ exists. ‘Greater than threshold’ (‘0’) represent that if a mobile terminal measures a signal from a system currently in service and a measurement results exceeds a specified value in field “Own System Threshold”, the mobile terminal is instructed to perform an event according to field ‘Event Identity’. “Smaller than threshold’ (‘1’) represent that if a mobile terminal measures a signal from a system currently in service and a measurement results is below a specified value in field “Own System Threshold”, the mobile terminal is instructed to perform an event according to field ‘Event Identity’.

Field ‘Own System Threshold’ designates a threshold applied to a source system, based upon which a mobile terminal judges whether or not to perform an activation/deactivation event according to a measurement result of a signal from a system currently in service. Field ‘Own System Threshold’ has a unit of dBm when a Received Signal Strength Indicator (RSSI) of the system signal or Received Signaling Code Power (RSCP) of a Common Pilot Channel (CPICH) is measured, and has a unit of dB when Noise-to-Chip Energy (Ec/No) of the CPICH is measured. In other words, the mobile terminal measures the intensity of a signal from a cell currently in service, that is, the RSSI or the RSCP and compares it with a specified value in field ‘Own System Threshold’ to determine whether or not to perform activation/deactivation.

Field ‘Other System threshold’ designates a threshold applied to a target system, based upon which a mobile terminal judges whether or not to perform an activation/deactivation event according to a measurement result of the RSSI from the target system.

Field ‘Own System measurement Quantity’ specifies one of the RSSI (‘0’), the Ec/No of the CPICH (‘1’) and the RSCP of the CPICH (‘2’) as a signal to be measured from a system currently in service.

Field ‘Other System measurement Quantity’ specifies which signal a mobile terminal measures from the target system. In a case of Table 2, the mobile terminal is specified to measure only the RRSSI of the target system before activation of the different kind of mode.

Field ‘Measured Own Cell List’ includes cell information of the source system, which is necessary for measuring a signal from the source system, when activation/deactivation of the mode defined in field ‘Other RAT Identity’ is controlled by field ‘Own System Threshold’. Field ‘Measured Own Cell List” is MP (Mandatory Present) when field ‘Own System Threshold’ exists and field ‘Own System Measurement Quantity’ does not specify the RSSSI. This is because the mobile terminal only has to measure the intensity of a received signal having a frequency in service without information about a specific cell in a case of the RSSI.

An example of a configuration of field ‘Measured Own Cell List’ is shown below in Table 3.

TABLE 3

| Information | | | |
|---|---|---|---|
| Element/Group name | Need | Multi | Description |
| Primary CPICH Info | MP | 1 | Primary Scrambling Code |
| Frequency Info | OP | 1 | Frequency |

As shown in Table 3, field “measured Own Cell List’ includes a primary scrambling code and frequency information as information about the primary CPICH for each cell.

A configuration of a message for reporting activation/deactivation of a different kind of mode is shown below in Table 4.

TABLE 4

| Information | | |
|---|---|---|
| Element/Group | | |
| name | Need | Description |
| Other RAT Identity | | 0: GSM, 1: cdma2000, 2: WCDMA, . . . etc. |
| Event Identity | | 0: deactivate. 1: activate |
| Reporting Time | | 0: start, 1: complete |
| Other System | | dBm |
| Measured Result | | |
| Own System | | when Measurement Quantity is RSSI, RSCP |
| Measured Result | | → dBm |
| | | when Measurement Quantity is Ec/No → |
| | | dB |

As shown in Table 4, fields ‘Other RAT Identity’, ‘Event Identity’ and ‘Reporting Time’ of fields constituting the message for reporting activation/deactivation of a different kind of mode are identical to those of the field in the message for controlling activation /deactivation of a different kind of mode. Field ‘Other System Measured Result’ designates a RSSI value (dB) of the target system measured by the mobile terminal, and field ‘Own System Measured Result’ designates an RSSI value (dBm), an RSCP value (dBm) or an Ec/No value (dB) of the source system measured by the mobile terminal.

The conditions for activation/deactivation of a different kind of mode depend on the intensity of a signal from a system currently in service and/or an RSSI of a target system. A mobile terminal measures the RSSI values of neighbor cells in a deactivated state of the different kind of mode using information about the neighbor cells and frequency information.

For example, if a mobile terminal in communication with the WCDMA system cannot measure an RSSI of a CDMA cell signal, the WCDMA system controller determines the mobile terminal to use only a source system threshold specified by field ‘Own System Threshold’. In contrast, if the mobile terminal can measure the RSSI of a CDMA cell signal, the WCDMA controller determines the mobile terminal to use a target system threshold or both the source system threshold and the target system threshold.

Field ‘Own System Criteria’ controls whether the mobile terminal on a border between different types of systems activates a different kind of mode at the edge of a cell (that is, a measured signal value exceeds the threshold) or in the center of a cell (that is, a measured signal value is below the threshold).

For example, when field ‘Own System Measurement Quantity’ specifies the CPICH Ec/No (‘1’) or the RSCP (‘2’) and it is intended to activate the CDMA mode of a mobile terminal at the edge of a cell belonging to a border of the WCDMA service area, the WCDMA controller sets field ‘Own System Criteria’ to ‘smaller than threshold’ (‘1’). On the contrary, when it is intended to activate the CDMA mode of a mobile terminal in the center of a cell belonging to a border of the WCDMA service area, the WCDMA controller sets field ‘Own System Criteria’ to ‘greater than threshold’ (‘0’).

To give another example, when field ‘Own System Measurement Quantity’ specifies the Path-Loss (‘3’) and it is intended to activate the CDMA mode of a mobile terminal at the edge of a cell belonging to a border of the WCDMA service area, the WCDMA controller sets field ‘Own System Criteria’ to ‘greater than threshold’ (‘0’). In contrast, when it is intended to activate the CDMA mode of a mobile terminal in the center of a cell belonging to a border of the WCDMA service area, the WCDMA controller sets field ‘Own System Criteria’ to ‘smaller than threshold’ (‘1’).

When activation/deactivation of a different kind of mode is controlled using the source system threshold indicated by field ‘Own System Threshold’, activation/deactivation conditions are as follows:

First of all, the activation conditions will be described.

When field ‘Own System Measurement Quantity’ indicates the CPICH RSCP (‘2’) or the Ec/No (‘1’) and field ‘measured Cell’ includes only a dummy cell, a mobile terminal activates a different kind of mode if a signal from a system currently in service, that is, a dummy cell signal specified in field ‘Measured Cell’ exceeds the threshold during the Time to Trigger. When field ‘measured Cell’ includes only a border cell, field ‘Own System Criteria’ is set to ‘greater than threshold’ (‘0’) or ‘smaller than threshold’ (‘1’) according to whether handover starts at the edges of the border cell or in the center of the border cell. When field ‘Own System Criteria’ is set to ‘greater than threshold’, the different kind of mode is activated if the signal intensity of the source system cell specified by field ‘Measured Cell’ exceeds the threshold during the Time to Trigger. When field ‘Own System Criteria’ is set to ‘smaller than threshold’, the different kind of mode is activated if the signal intensity of the source system cell specified by field ‘Measured Cell’ is less than the threshold during the Time to Trigger.

When field “Own System Measurement Quantity’ indicates the Path-Loss, this case is the very reverse to the case of using the CPICH RSCP or the CPICH Ec/No because the less a value of the Path-Loss is, the better signal quality received in a mobile terminal is.

Next, the deactivation conditions will be described.

When field ‘Own System Criteria’ of the deactivation event is set to ‘greater than threshold’ (‘0’), a mobile terminal deactivates a different kind of mode if the signal intensity of a cell specified by field ‘Measured Cell’ exceeds the threshold during a Time to Trigger. In contrast, when field ‘Own System Criteria’ of the deactivation event is set to ‘smaller than threshold’ (‘1’), the mobile terminal deactivates the different kind of mode if the signal intensity of a cell specified by field ‘Measured Cell’ is below the threshold during the Time to Trigger.

If field ‘Own System Measurement Quantity’ does not indicate the RSSI (‘0’), that is, indicates the CPICH RSCP (‘2’), the Ec/No (‘1’) or the Path-Loss (‘3’), the mobile terminal measures the CPICH RSCP or the Ec/No of neighbor cells specified in field ‘Measured Cell’ to check the activation/deactivation conditions. However, if field ‘Own System Measurement Quantity’ indicates the RSSI (‘0’), the mobile terminal need not measure signals from the neighbor cells.

Hereinafter, a description will be given for activation/deactivation conditions in a case where it is intended to control activation/deactivation of a different kind of mode using the target system threshold indicated by field ‘Other System Threshold’. In this case, a mobile terminal judges whether to activate or deactivate the different kind of mode according to a measured RSSI value of a signal received from the handover target system.

If the measured RSSI value MOTHER of the handover target system exceeds the target system threshold TOTHER during a Time to Trigger (M_{OTHER}>T_{OTHER}), the mobile terminal activates the different kind of mode. On the contrary, if the measured RSSI value M_{OTHER} of the handover target system is below the target system threshold T_{OTHER} during the Time to Trigger (M_{OTHER}<T_{OTHER}), the mobile terminal deactivates the different kind of mode.

Finally, when it is intended to control activation/deactivation of a different kind of mode using both the source system threshold and the target system threshold, a mobile terminal compares measured values of the source system and the target system with the source system threshold and the target system threshold, respectively to activate or deactivate the different kind of mode if the above-mentioned conditions are simultaneously satisfied.

The WCDMA or CDMA system controller controls the mode shift conditions of a mobile terminal currently in communication with the system through the message for controlling activation/deactivation of a different kind of mode. When the mobile terminal in communication receives the message for controlling activation/deactivation of a different kind of mode, it stores all information of the message and measures the source system signal and/or the target system signal according to the corresponding conditions.

The mobile terminal also judges the conditions specified by the control message based upon the measurement results, and performs the activation/deactivation of a different kind of mode if the specified conditions are satisfied. Whether or not to perform the activation/deactivation is reported to the system controller through the message for reporting activation/deactivation of a different kind of mode.

If field ‘Reporting Time’ is set to ‘start’ (‘0’), the mobile terminal reports the activation/deactivation event at the start of activation/deactivation. If field ‘Reporting Time’ is set to ‘complete’ (‘1’), the mobile terminal reports the activation/deactivation event at the completion of activation/deactivation. Also, if field ‘Reporting Time’ is set to ‘start and complete’ (‘2’), the mobile terminal reports the activation/deactivation event at both the start and completion of activation/deactivation.

When received the activation event from the mobile terminal, the system controller progresses handover into the different type target system.

2. Determination on activation/deactivation

In a preferred embodiment of the present invention, information about a border cell or a signal from a dummy cell is used as information for determining handover in a border zone between different types of systems.

The border cell signifies a cell which adjoins the service area of another RAT system at a border of one RAT system. The dummy cell signifies a cell which, for example, transmits a signal of a WCDMA downlink common channel to the neighbor CDMA service area adjoining the WCDMA service area. For example, a WCDMA dummy cell transmits a signal of a WCDMA downlink common channel such as a Primary Synchronization Channel (P-SCH), a Secondary Synchronization Channel (S-SCH) or a Primary Common Pilot Channel (P-CPICH).

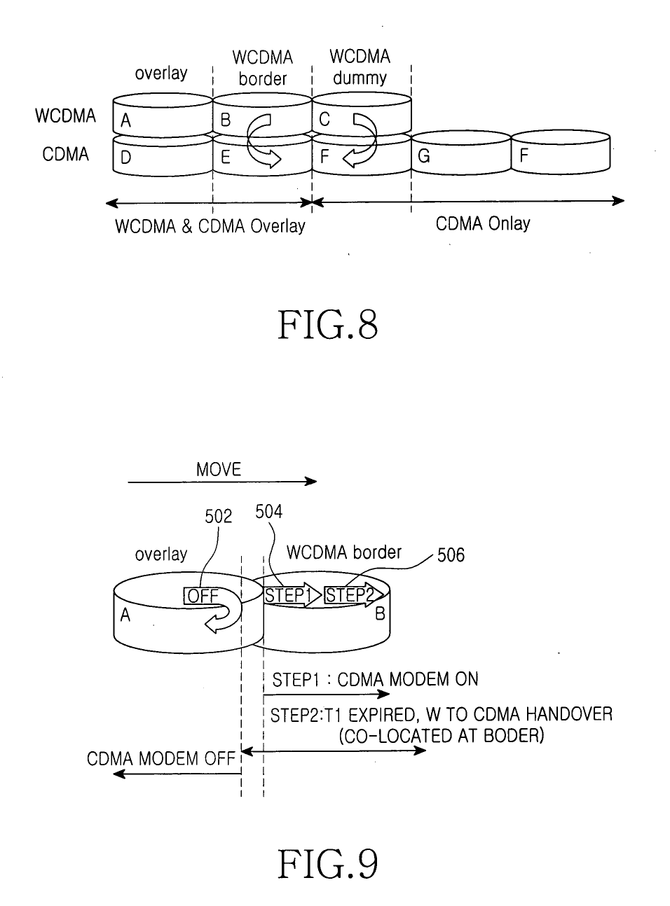

FIG. 8 illustrates an example of network structures of a WCDMA system and a CDMA system which can be applied to the present invention.

Referring to FIG. 8, cells A, B and C belong to the WCDMA service area, and cells D, E, F, G and F belong to the CDMA service area. Since cell A overlays cell D, cells A and D are overlay cells belonging to a service overlay zone between the different types of systems. Since cell B neighbors the CDMA service area while belonging to the WCDMA service area, it becomes a border cell. Cell C co-located with cell F is a dummy cell which transmits a signal of a WCDMA downlink common channel through a frequency channel assigned to the WCDMA system.

In a case of the first embodiment described with reference to FIG. 6, the source system determines activation/deactivation of a mobile terminal's different kind of mode using information about a border cell. In a case of the second embodiment described with reference to FIG. 7, a mobile terminal directly determines activation/deactivation of a different kind of mode using a signal from a dummy cell.

Herein after, these embodiments will be dividedly described.

FIG. 9 illustrates a view for explaining a handover process between different types of systems in accordance with the first embodiment of the present invention.

Referring to FIG. 9, a mobile terminal is in communication with a source system while turning off modules related to a different type of system (a target system) into which the mobile terminal performs handover, that is, deactivating a target system mode (step 502). The first step (step 504) begins with the entrance of the mobile terminal into the border cell B. In the first step (step 504), a source system controller (RNC in the WCDMA system and BSC in the CDMA system) instructs the mobile terminal to enable the modules related to the target system, that is, activate the target system mode before handover is performed. In the second step (step 506), the source system controller waits for a predetermined time T1. The predetermined time T1 is a time which is predicted to be required for the mobile terminal to activate the modules related to the target system and acquire sync of the target system, and is determined by actual measurement.

After the time Ti has passed, the source system controller checks whether or not the mobile terminal is still located in the border cell B. If the mobile terminal is still located in the border cell B, the source system controller performs handover into the target system. In contrast, if the mobile terminal escapes from the border cell B and returns to the overlay cell A before the time Ti expires, the source system controller instructs the mobile terminal to deactivate the modules related to the target system.

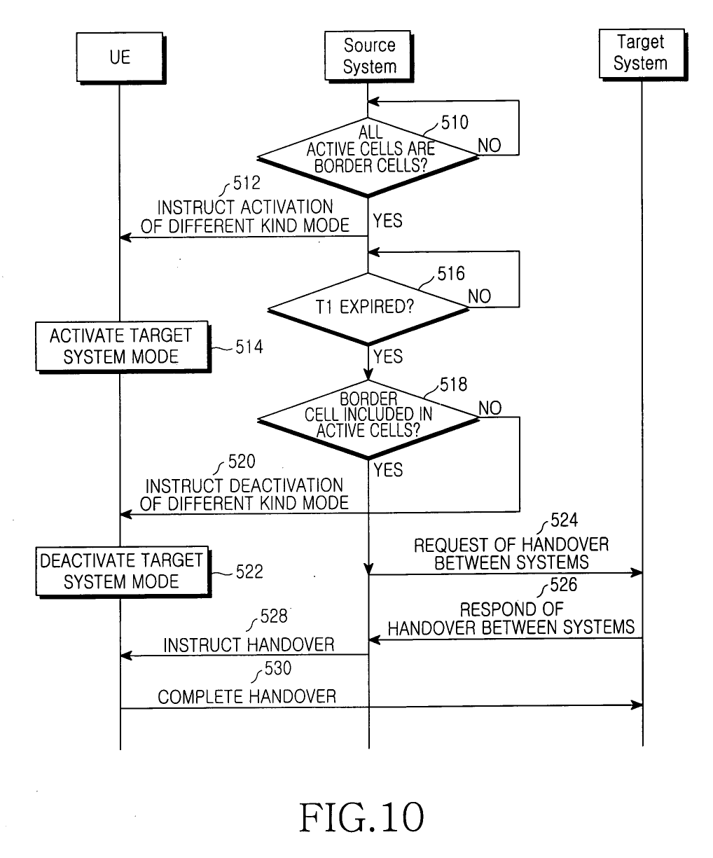

FIG. 10 illustrates a message flowchart showing a handover process between different types of systems by using information about a border cell in accordance with the first embodiment of the present invention. Here is shown a process of performing the handover from the WCDMA service area into the CDMA service area by way of example.

Referring to FIG. 10, a source system checks whether or not all cells with which a mobile terminal in a traffic state can communicate, that is, all active cells are border cells (step 510). If all the cells are border cells, the source system transmits a message for instructing activation of a different kind of mode to the mobile terminal and so instructs the mobile terminal to activate a target system mode in order to get ready for handover into the target system (step 512). In response to the message for instructing activation of a different kind of mode, the mobile terminal activates modules related to the target system and initializes a modem and software to start cell searching of the target system (step 514).

After having transmitted the activation-instructing message, the source system waits for a predetermined time T1 (step 516). When the time T1 has passed, the source system checks whether or not border cells are still included in the active cells of the mobile terminal (step 518). If border cells are not included in the active cells, the source system transmits a message for instructing deactivation of a different kind of mode to the mobile terminal (step 520), and the mobile terminal responds to the message by deactivating the modules related to the target system (step 522 ).

On the contrary, if at least a border cell is still included in the active cells, the source system determines to perform handover into a cell of the target system, which neighbors at least the border cell, and request handover between the systems to the target system (step 524). If a response to the request of the handover between the systems is received from the target system, the source system instructs the mobile terminal to perform the handover (step 528). The mobile terminal directly attempts access to the target system without performing shift between modes. If succeeding in access to the target system, the mobile terminal is connected to the target system to report handover completion to the target system.

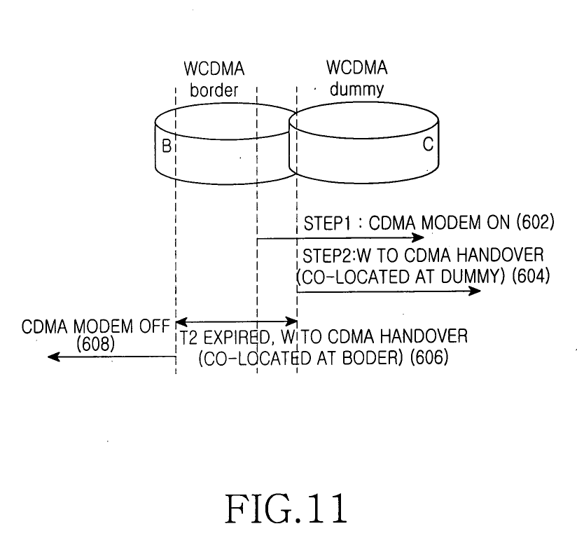

FIG. 11 illustrates a view for explaining a handover process between different types of systems in accordance with the second embodiment of the present invention. Here is shown a process of performing the handover from the WCDMA service area into the CDMA service area by way of example.

Referring to FIG. 11, a mobile terminal detects a signal transmitted from a dummy cell C of a target system, for example, a signal of a CDMA downlink common channel (P-CPICH) in a case where the target system is the CDMA system. If the signal from the dummy cell exceeds a predetermined threshold, the mobile terminal activates modules related to the target system (step 602). Once the modules related to the target system are activated, the mobile terminal continues to monitor the signal from the dummy cell. If the intensity of the signal from the dummy cell is greater than the intensity of a signal from a source system, the mobile terminal performs handover into a cell of the target system, which is co-located with the dummy cell (step 604).

If the signal from the dummy cell is not greater than that from the source system during a predetermined time T2 after the activation of the target system-related modules, but continually exceeds the threshold, the mobile terminal performs handover into a cell of the target system, which is co-located with the dummy cell, under the control of the source system (step 606). This aims to prevent unnecessary power consumption of the mobile terminal due to keeping the target system modules activated. That is, the time T2 is a maximum time during which the mobile terminal allows two RAT modes to be simultaneously activated, and has a greater value than that of the T1.

If the signal from the dummy cell is less than the threshold or the mobile terminal returns from the border cell B to the overlay cell before the expiration of the time T2, the mobile terminal deactivates the target system-related modules again (step 608).

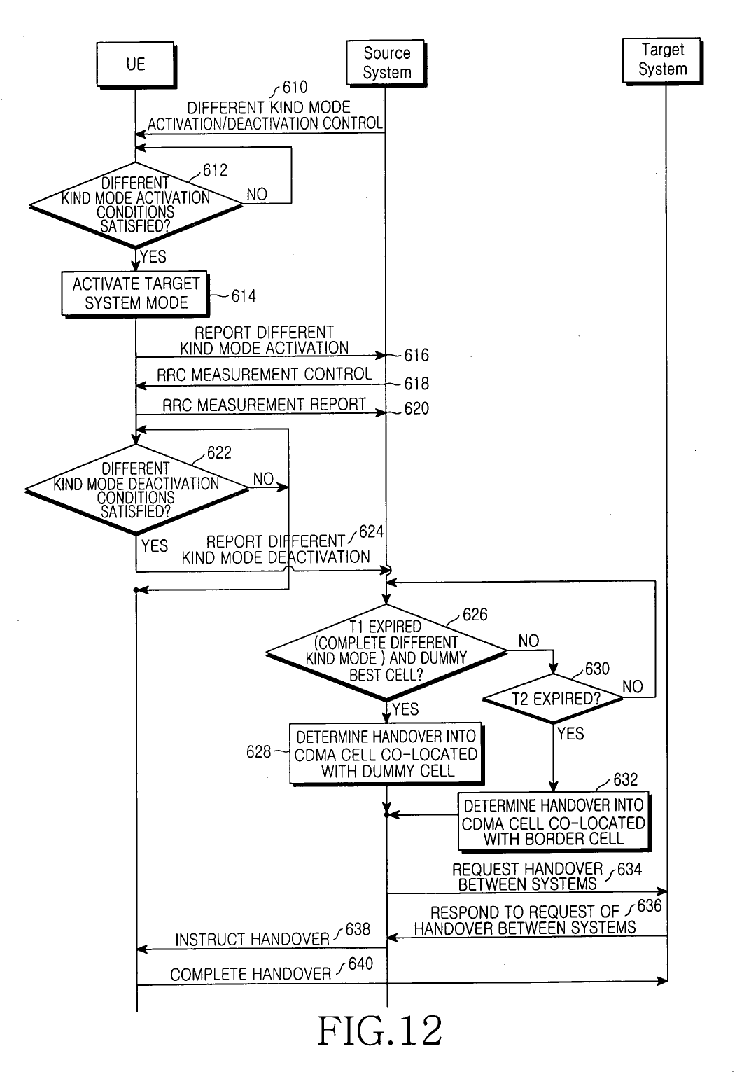

FIG. 12 illustrates a message flowchart showing a handover process between different types of systems by using a signal from a dummy cell in accordance with the second embodiment of the present invention.

Referring to FIG. 12, if a mobile terminal (UE) in a traffic state enters a border cell, a source system controller transmits a message for controlling activation of a different kind of mode, including information about activation/deactivation conditions according to a threshold of a signal from a dummy cell, to the mobile terminal (step 610). The mobile terminal judges whether or not a current mode of a target system is in a deactivated state and the intensity of the signal from the dummy cell exceeds the target system threshold specified by the control message (step 612). If these conditions are satisfied, the mobile terminal activates modules related to the target system and initializes a modem and software to start cell searching of the target system (step 614). The mobile terminal reports the activation of the different kind of mode to the source system (step 616). As stated above, step 616 may be omitted.

The source system instructs the mobile terminal to report a measured value of the signal from the dummy cell (step 618). In the WCDMA system, a Radio Resource Control (RCC) Measurement Control message is used in step 618. In response to the RRC Measurement Control message, the mobile terminal reports the measured value of the signal from the dummy cell continually or every event-triggered (step 620).

The mobile terminal judges whether or not a current mode of the target system is in an activated state and deactivation conditions of a different kind of mode are satisfied, that is, the intensity of the signal from the dummy cell is less than the target system threshold (step 622). If the intensity of the signal from the dummy cell is less than the target system threshold, the mobile terminal deactivates the target system-related modules and reports the deactivation of the different kind of mode to the source system (step 624).

In the meantime, if the deactivation of the different kind of mode is not reported from the mobile terminal, the source system waits for a predetermined time T1 after the mobile terminal has reported the activation of the different kind of mode, and then judges whether or not the dummy cell monitored by the mobile terminal is the best cell (step 626). Here, the predetermined time T1 is a time which is predicted to be required for the mobile terminal to activate the different kind of mode, and may be about 10 seconds. The best cell signifies a cell having the maximum signal intensity from among all the active cells which the mobile terminal can detects.

If the dummy cell is the best cell, the source system determines to perform handover into a cell of the target system, which is co-located with the dummy cell (step 628). In contrast, if the dummy cell is not the best cell, the source system judges whether or not a predetermined time T2 has passed since the mobile terminal reported the activation of the different kind of mode (step 630). The time T2 signifies a maximum time during which the mobile terminal allows the different kind of mode to be activated while not performing the handover. If the intensity of the signal from the dummy cell keeps exceeding the target system threshold and the time T2 expires even if the dummy cell is not the best cell, the source system determines to perform into a neighbor cell of the target system (step 632). At this time, the source system determines to perform handover into a target system cell co-located with the border cell in which the mobile terminal is currently located. That is, the source system proceeds to step 532 if the deactivation of the different kind of mode is not reported from the mobile terminal by the expiration of the time T2.

The source system requests the handover between the systems to the target system (step 634). If a response to the request of the handover between the systems is received from the target system, the source system instructs the mobile terminal to perform the handover (step 638). The mobile terminal directly attempts access to the target system without performing shift between modes. If succeeding in access to the target system, the mobile terminal is connected to the target system to report handover completion to the target system.

In the embodiments as described above, it is assumed that the source system controller has already known whether the cells detected by the mobile terminal are border cells or dummy cells. However, when the mobile terminal has performed handover. between system controllers, a system controller controlling communication and handover the mobile terminal may be different from a system controller in which the mobile terminal is actually located.

When a mobile terminal moves from the service area of one system controller (source system controller) to the service area of another system controller (target system controller) within the service area of one RAT system, the source system controller continues to control communication and handover the mobile terminal through the target system controller. At this time, if the target system controller neighbors the different type of system, the source system controller is provided with information about border and dummy cells of the target system controller in order to control handover the mobile terminal.

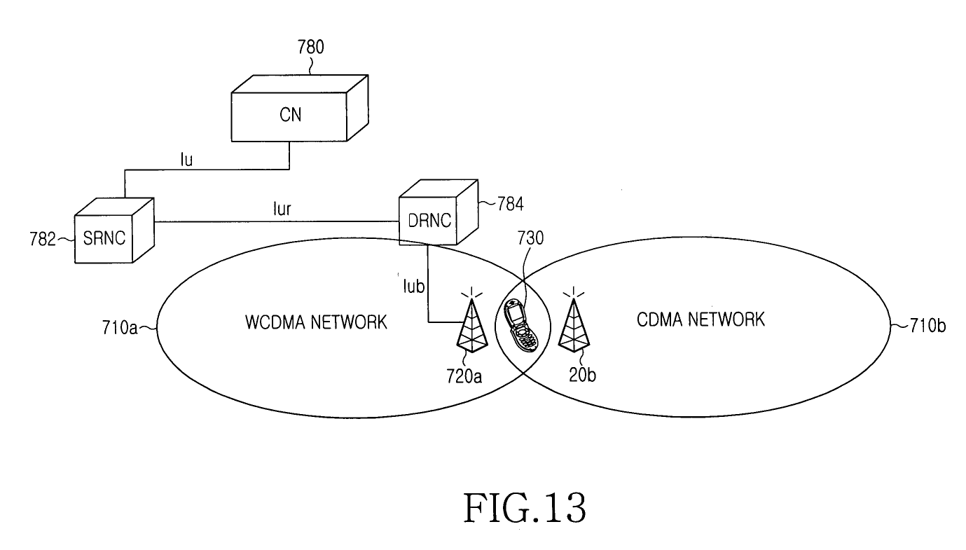

FIG. 13 illustrates a view for explaining a handover process into a different type of system in a handover state between system controllers in accordance with another preferred embodiment of the present invention.

Referring to FIG. 13, a Serving RNC (SRNC) 782 is a system controller which has initially connected a call to a mobile terminal 730, and a Drift RNC (DRNC) 784 is a system controller which currently connects a call to the mobile terminal 730 through a base station 720a. Here, the base station 720a is connected to the DRNC 784 through an interface called ‘Iub’, the DRNC 784 is connected to the SRNC 782 through an interface called ‘Iur’, and the SRNC 782 is connected to a Core Network (CN) 780 through an interface called ‘Iu’.

The mobile terminal 730 is located in a border zone between the service area 710a of the base station 720a belonging to the DRNC 784 and a neighbor cell 710b of the CDMA service area. The SRNC 782 has information about border cells and dummy cells belonging to the DRNC 784 as well as information about co-located CDMA cells.

At a point of time when the cell 720a belonging to the DRNC 784 is added to an Active Set of the mobile terminal 730, the SRNC 782 receives information about neighbor cells of the Active Set, to which the cell is added, from the DRNC 784 to update the information. Here, the information about neighbor cells includes information about border cells and dummy cells belonging to the Active Set of the mobile terminal 730. That is, when the DRNC 784 transmits the information about neighbor cells to the SRNC, cell configuration indicating whether the relevant neighbor cells are border or dummy cells is included in the information. An example of a configuration of the information about neighbor cells is shown below in Table 5.

As shown in Table 5, the information about neighbor cells includes a 12-bit RNC Identifier (RNC-ID) representing the DRNC, a 16-bit Cell Identifier (C-ID) for neighbor cells, a Primary Scrambling Code of each neighbor cell, a Restriction State Indicator representing whether or not each neighbor cell is available, and Cell Configuration Information indicating a type of each neighbor cell. The types of neighbor cells include a normal cell, a border cell and a dummy cell.

TABLE 5

| Information Element name | Description |
|---|---|
| RNC-ID | 0˜4096 |
| C-ID | 0˜65535 |
| Primary Scrambling Code | |
| Restriction State Indicator | Enumerator (Cell not reserved for |
| | operator use, Cell reserved for operator |
| | use, . . . ) |
| Cell Configuration | Enumerator (normal cell, border cell, |
| | dummy cell, . . . ) |

The information about neighbor cells is transmitted from the DRNC to the SRNC while included in a Radio Network Service Access Point (RNSAP) Radio Link Addition Response message or an RNSAP Radio Link Setup Response message. The SRNC checks whether the neighbor cell to which the mobile terminal moves is a border cell or a dummy cell by means of the information about neighbor cells, based upon to which it can determine whether or not perform handover.

In the handover between the system controllers, the SRNC requests a cell within the DRNC to set handover resources by transmitting an RNSAP Radio Link Setup Request message or an RNSAP Radio Link Addition Request message. The DRNC instructs the cell specified by the Request message to assign a traffic channel, and then responds to the request of the SRNC by transmitting the RNSAP Radio Link Addition Response message or the RNSAP Radio Link Setup Response message to the SRNC.

Although field ‘Cell Configuration’ indicating a type of each neighbor cell is shown in Table 5, this means that burdens of additional bits and change in configuration of the information about neighbor cells may be incurred. Thus, modified embodiments for eliminating such burdens will be described below.

In one modified embodiment, whether each neighbor cell is a border cell or a dummy cell is indicated using most significant 2 bits of each 16-bit C-ID.

That is, if the most significant bit (bit 15) is ‘1’, the neighbor cell is a dummy cell, and if the next most significant bit (bit 14) is ‘1’, the neighbor cell is a border cell. In another modified embodiment, the Restriction State Indicator is used for indicating the types of the neighbor cells. That is, whether each neighbor cell is a border cell or a dummy cell is indicated using some bits of the Restriction State Indicator as in the C-ID.

The DRNC 784 also provides information about different types of cells co-located with the border cells and the dummy cells together with the information about neighbor cells to the SRNC 782. This information is provided so that the SRNC 782 can progress handover into a different type of system.

An example of a configuration of information about different types of cells for the WCDMA system is shown below in Table 6. Here is shown information about neighbor cells of the CDMA systems.

TABLE 6

| Information Element name | Description |
|---|---|
| PLMN-ID | Network Identifier |
| MSC-ID | Mobile Switching Center Identifier |
| BS-ID | Base Station Identifier (BSC-ID + BTS- |
| | ID + FA-ID + Sector-ID) |
| PN offset | Base Station Pilot PN offset |
| Frequency | Downlink Frequency |

As shown in Table 6, the information about different types of cells includes a Public Land Mobile Network (PLMN) Identifier (PLMN-ID), that is, an identifier of a network to which different types of neighbor cells belong, an identifier (MSC-ID) of a Mobile Switching Center (MSC) to which different types of neighbor cells belong, a Base Station (BS) Identifier (BS-ID) representing each neighbor cell, an Pilot Pseudo-random Noise (PN) offset (PN offset) for each base station, and a downlink frequency band. The BS-ID includes a Base Station Controller (BSC) Identifier (BSC-ID), a Base Station Transceiver (BTS) Identifier (BTS-ID), a Frequency Assignment (FA) Identifier (FA-ID) and a Sector Identifier (Sector-ID).

Base upon the information as configured above, the SRNC 782 recognizes a target cell into which a mobile terminal perform handover, and requests handover between different types of systems, that is, the handover into the target cell to a system controller of the target cell (that is, a target system controller).

### INDUSTRIAL APPLICABILITY

As can be seen from the foregoing, effects obtained from typical embodiments of the present invention as described above can be summarized as follows:

In the present invention aiming at handover between different types of systems, a system controller controls activation/deactivation of a different kind of mode of a mobile terminal, activates the different kind of mode of the mobile terminal in advance before the handover is performed and then performs the handover after the completion of the activation, thereby minimizing a time required for performing the handover between different types of systems. This prevents failure of the handover due to the expiration of a waiting time for the handover completion in a target system. The minimized time taken for performing the handover also prevents failure of the handover or degradation in communication quality due to the signal deterioration of the system in service. In a conventional handover method, the different kind of mode may be activated even when the handover is not performed, so that two different kinds of modes may be simultaneously activated in the mobile terminal, which results in increase of power consumption. On the contrary, this can be prevented in the present invention because the system controller can know an activation/deactivation status and duration of the different kinds of modes of the mobile terminal. Furthermore, even in a handover state between system controllers, the present invention can efficiently perform the handover using information about dummy cells and information about border cells.

Although described above with respect to a case of handover between the IMT-2000 WCDMA system and the CDMA2000 system, the present invention can be similarly applied to handovers between other systems simultaneously supporting different standards from each other.

While the invention has been shown and described with reference to certain preferred embodiments thereof, it will be understood by those skilled in the art that various changes in form and details may be made therein without departing from the spirit and scope of the invention as defined by the appended claims.

1. A method for controlling a system mode of an MMMB mobile terminal, which is capable of access to a source system and a target system employing different wireless access technologies from each other, in order to perform hard handover between different types of systems employing the different wireless access technologies from each other, the method comprising the steps of:
judging whether or not activation conditions of a target system mode related to the target system are satisfied with respect to the mobile terminal in communication with the source system;
transmitting an activation instruction message instructing activation of the target system mode to the mobile terminal if the activation conditions are satisfied; and
performing the mobile terminal's handover into the target system if the handover into the target system is determined after the transmission of the instruction message.

2. The method as claimed in claim 1, wherein the activation instruction message includes an information field clarifying the wireless access technology of the target system and an activation field instructing the activation of the target system mode.

3. The method as claimed in claim 1, wherein in the judging step, it is determined to activate target system-related modules of the mobile terminal if the mobile terminal is located in a border cell neighboring the target system.

4. The method as claimed in claim 3, wherein in the handover performing step, the handover is performed if the mobile terminal is still located in the border cell until a predetermined time T1 passes after the transmission of the activation instruction message.

5. The method as claimed in claim 1, wherein in the judging step, it is determined to activate target system-related modules of the mobile terminal if all active cells in communication with the mobile terminal are border cells neighboring the target system.

6. The method as claimed in claim 5, wherein the handover performing step comprises the substeps of:
waiting for a predetermined time T1, which is predicted to be required for activating the target system mode by the mobile terminal, after the transmission of the instruction message;
determining handover into a cell of the target system, which neighbors at least one border cell, if the at least one border cell neighboring the target system is included in the active cells in communication with the mobile terminal after the waiting for the predetermined time T1, and requesting the handover between the systems to the target system; and
receiving a response to the request of the handover between the systems and instructing the mobile terminal to perform the handover into the target system.

7. The method as claimed in claim 1, further comprising the steps of:
waiting for a predetermined time T1, which is predicted to be required for activating the target system mode by the mobile terminal, after the transmission of the instruction message;
judging whether or not at least one border cell neighboring the target system is included in the active cells in communication with the mobile terminal after the waiting for the predetermined time T1; and
transmitting a deactivation instruction message instructing deactivation of the target system mode to the mobile terminal if no border cell is included in the active cells.

8. The method as claimed in claim 1, wherein a DRNC controlling a cell in which the mobile terminal is located provides information about border cells belonging to the DRNC to a SRNC to which the mobile terminal has initially connected a call.

9. A method for controlling a system mode of an MMMB mobile terminal, which is capable of access to a source system and a target system employing different wireless access technologies from each other, in order to perform hard handover between different types of systems employing the different wireless access technologies from each other, the method comprising the steps of:
receiving an activation instruction message instructing activation of a target system mode related to the target system from the source system in communication with the mobile terminal;
activating the target system mode to search the target system in response to the activation instruction message; and
performing handover into the target system if the handover into the target system is instructed from the source system.

10. The method as claimed in claim 9, wherein the activation instruction message includes an information field clarifying the wireless access technology of the target system and an activation field instructing the activation of the target system mode.

11. The method as claimed in claim 9, wherein in the handover performing step, the mobile terminal attempts access to the target system, and connects to the target system to report handover completion to the target system if it succeeds in the access to the target system.

12. The method as claimed in claim 9, further comprising the step of:
receiving a deactivation instruction message instructing deactivation of the target system mode related to the target system from the source system to respond to the deactivation instruction message by deactivating the target system mode.

13. A method for controlling a system mode of an MMMB mobile terminal, which is capable of access to a source system and a target system employing different wireless access technologies from each other, in order to perform hard handover between different types of systems employing the different wireless access technologies from each other, the method comprising the steps of:
transmitting an activation/deactivation control message including activation or deactivation conditions of a target system mode related to the target system to the mobile terminal in communication with the source system;
receiving an activation event report notifying that the target system mode has been activated from the mobile terminal; and
performing mobile terminal's handover into the target system if the handover into the target system is determined after the reception of the activation event report.

14. The method as claimed in claim 13, wherein the activation/deactivation control message includes an information field clarifying the wireless access technology of the target system, an activation field instructing whether or not to activate the target system mode, a point of time of the activation event report, a system threshold of the source system or the target system and a criteria of the threshold, and information indicating which signal is measured from the source system or the target system.

15. The method as claimed in claim 14, wherein the activation/deactivation control message further includes information about cells of the source system, which is necessary for measuring the signal of the source system when the activation/deactivation of the mobile terminal is controlled by the system threshold of the source system.

16. The method as claimed in claim 13, wherein the handover performing step comprises the substeps of:
determining the handover into the target system and requesting the handover between the systems to the target system if the activation event report is received; and
receiving a response to the request of the handover between the systems and instructing the mobile terminal to perform the handover into the target system.

17. The method as claimed in claim 13, wherein the handover performing step comprises the substeps of:
judging whether or not the mobile terminal is located in a dummy cell of the source system, which is co-located with the service area of the target system, until a predetermined time T1 passes after the reception of the activation event report; and
determining handover into a cell of the target system, which is co-located with the dummy cell, if the mobile terminal is located in the dummy cell.

18. The method as claimed in claim 13, wherein the handover performing step comprises the substeps of:
judging whether or not the mobile terminal is located in a dummy cell of the source system, which is co-located with the service area of the target system, until a predetermined time T1 passes after the reception of the activation event report;
judging whether or not the dummy cell is the best cell for the mobile terminal if the mobile terminal is located in the dummy cell; and
determining handover into a cell of the target system, which is co-located with the dummy cell, if the dummy cell is the best cell.

19. The method as claimed in claim 18, wherein the handover performing step further comprises the substeps of:
waiting for a predetermined time T2 more than the time T1 after the reception of the activation event report if the dummy cell is not the best cell; and
determining handover into a cell of the target system, which neighbors the dummy cell, if a deactivation event report notifying that the target system mode has been deactivated is not received from the mobile terminal until the predetermined time T2 passes.

20. The method as claimed in claim 13, wherein the handover performing step comprises the substep of:
requesting the mobile terminal's handover between the systems to the target system, and instructing the mobile terminal to perform the handover into the target system if a response to the request of the handover between the systems is received from the target system.

21. A method for controlling a system mode in order to perform hard handover between different types of systems employing different wireless access technologies from each other in an MMMB mobile terminal capable of access to a source system and a target system employing the different wireless access technologies from each other, the method comprising the steps of:
receiving an activation/deactivation control message including activation or deactivation conditions of a target system mode related to the target system from the source system in communication with the mobile terminal;
measuring at least one of a signal from the source system and a signal from the target system to judge whether or not the activation or deactivation conditions are satisfied;
activating the target system mode so as to search the target system if the activation conditions are satisfied as a result of the judgment; and
performing handover into the target system if the handover into the target system is instructed from the source system.

22. The method as claimed in claim 21, wherein the activation/deactivation control message includes an information field clarifying the wireless access technology of the target system, an activation field instructing whether or not to activate the target system mode, a point of time of an activation event report notifying that the target system mode has been activated, a system threshold of the source system or the target system and a criteria of the threshold, and information indicating which signal is measured from the source system or the target system.

23. The method as claimed in claim 22, wherein the activation/deactivation control message further includes information about cells of the source system, which is necessary for measuring the signal of the source system when the activation/deactivation of the mobile terminal is controlled by the system threshold of the source system.

24. The method as claimed in claim 21, wherein in the judging step, if the signal from the source system is measured with the result that the signal from the source system is below a source system threshold included in the activation/deactivation control message, it is judged that the activation conditions are satisfied.

25. The method as claimed in claim 21, wherein in the judging step, if the signal from the target system is measured with the result that the signal from the target system exceeds a target system threshold included in the activation/deactivation control message, it is judged that the activation conditions are satisfied.

26. The method as claimed in claim 21, wherein in the judging step, if the signals from the source system and the target systems are measured with the result that the signal from the source system is below a source system threshold included in the activation/deactivation control message and the signal from the target system exceeds a target system threshold included in the activation/deactivation control message, it is judged that the activation conditions are satisfied.

27. The method as claimed in claim 21, further comprising the step of:
transmitting an activation event report notifying that the target system mode has been activated to the source system after the activation of the target system mode.

28. The method as claimed in claim 27, wherein the activation event report includes an information field clarifying the wireless access technology of the target system and an activation field instructing whether or not the target system mode has been activated.

29. The method as claimed in claim 27, wherein in the event report transmitting step, the event report is transmitted at the start of the activation of the target system mode related to the target system, after the completion of the activation of the target system mode related to the target system or at the start and after the completion of the activation of the target system mode related to the target system.

30. The method as claimed in claim 21, further comprising the step of:
deactivating the target system mode related to the target system and transmitting a deactivation event report notifying that the target system mode has been deactivated to the source system if the deactivation conditions are satisfied as a result of the judgment.

31. The method as claimed in claim 30, further comprising the step of:
judging the deactivation conditions to be satisfied if the signal from the source system is measured with the result that the signal from the source system exceeds a source system threshold included in the activation/deactivation control message during a predetermined time.

32. The method as claimed in claim 30, further comprising the step of:
judging the deactivation conditions to be satisfied if the signal from the target system is measured with the result that the signal from the target system is below a target system threshold included in the activation/deactivation control message during a predetermined time.

33. The method as claimed in claim 21, wherein in the handover performing step, the mobile terminal attempts access to the target system, and connects to the target system to report handover completion to the target system if it succeeds in the access to the target system.

34. The method as claimed in claim 21, wherein in the judging step, it is determined that the activation conditions are satisfied if the target system mode is deactivated and the mobile terminal is located in a dummy cell of the source system, which is co-located with the service area of the target system.

35. The method as claimed in claim 34, wherein if the intensity of a signal received from the dummy cell exceeds a target system threshold specified by the activation/deactivation control message, it is judged that the mobile terminal is located in the dummy cell.

36. The method as claimed in claim 21, wherein in the judging step, it is determined that the deactivation conditions are satisfied if the target system mode is activated and the mobile terminal is not located in a dummy cell of the source system, which is co-located with the service area of the target system.

37. The method as claimed in claim 36, wherein if the intensity of a signal received from the dummy cell is below a target system threshold specified by the activation/deactivation control message, it is judged that the mobile terminal is not located in the dummy cell.

38. A method for performing hard handover between systems employing different wireless access technologies from each other, the method comprising the steps of:
judging whether or not a mobile terminal in communication with the source system is located in a border cell neighboring the target system;
transmitting an activation instruction message instructing activation of modules related to the target system to the mobile terminal if the mobile terminal is located in the border cell; and
performing handover into the target system if the mobile terminal is still located in the border cell until a predetermined time T1 passes after the transmission of the activation instruction message.

39. The method as claimed in claim 38, wherein in the judging step, it is determined that the target system-related modules of the mobile terminal are activated if all active cells in communication with the mobile terminal are birder cells neighboring the target system.

40. The method as claimed in claim 38, further comprising the steps of:
waiting for a predetermined time T1, which is predicted to be required for activating the target system-related modules by the mobile terminal, after the transmission of the instruction message;
judging whether or not at least one border cell neighboring the target system is included in the active cells in communication with the mobile terminal after the waiting for the predetermined time T1; and
transmitting a deactivation instruction message instructing deactivation of the target system-related modules to the mobile terminal.

41. The method as claimed in claim 38, wherein the handover performing step comprises the substeps of:
waiting for a predetermined time T1, which is predicted to be required for activating the target system-related modules by the mobile terminal, after the transmission of the instruction message;
determining handover into a cell of the target system, which neighbors at least one border cell, if the at least one border cell neighboring the target system is included in the active cells in communication with the mobile terminal after the waiting for the predetermined time T1, and requesting the handover between the systems to the target system; and
receiving a response to the request of the handover between the systems and instructing the mobile terminal to perform the handover into the target system.

42. The method as claimed in claim 38, wherein a DRNC in which the mobile terminal is located provides information about border cells belonging to the DRNC to a SRNC within the source system, to which the mobile terminal has initially connected a call.

43. A method for performing hard handover between systems employing different wireless access technologies from each other, the method comprising the steps of:
receiving an activation event report notifying that modules related to a target system have been activated from a mobile terminal as the mobile terminal in communication with a source system is located in a dummy cell of the source system, which is co-located with the service area of the target system; and
performing handover into a cell of the target system, which is co-located with the dummy cell, if it is confirmed that the mobile terminal is located in the dummy until a predetermined time passes after the reception of the activation event report.

44. The method as claimed in claim 43, wherein the handover performing step comprises the substeps of:
judging whether or not the dummy cell is the best cell for the mobile terminal if a predetermined time T1 passes after the reception of the activation event report; and
determining the handover into the cell of the target system, which is co-located with the dummy cell, if the dummy cell is the best cell.

45. The method as claimed in claim 44, wherein the handover performing step further comprises the substeps of:
waiting for a predetermined time T2 more than the time T1 after the reception of the activation event report if the dummy cell is not the best cell; and
determining handover into a cell of the target system, which neighbors the dummy cell, if a deactivation event report notifying that the target system-related modules have been deactivated is not received from the mobile terminal until the predetermined time T2 passes.

46. The method as claimed in claim 43, wherein the handover performing step comprises the substep of:
requesting the mobile terminal's handover between the systems to the target system, and instructing the mobile terminal to perform the handover into the target system if a response to the request of the handover between the systems is received from the target system.

47. The method as claimed in claim 43, wherein a DRNC in which the mobile terminal is located provides information about dummy cells belonging to the DRNC to a SRNC to which the mobile terminal has initially connected a call.

48. A method for performing hard handover between systems employing different wireless access technologies from each other, the method comprising the steps of:
activating modules related to a target system so as to search the target system if the target system-related modules are deactivated and a mobile terminal is located in a dummy cell of the source system, which is co-located with the service area of the target system; and
performing handover into the target system if the handover into the target system is instructed from the source system.

49. The method as claimed in claim 48, wherein if the intensity of a signal received from the dummy cell exceeds a target system threshold specified by an activation/deactivation control message, it is judged that the mobile terminal is located in the dummy cell.

50. The method as claimed in claim 48, further comprising the step of:
transmitting an activation event report notifying that the target system-related modules have been activated to the source system after the activation of the target system-related modules.

51. The method as claimed in claim 48, further comprising the step of:
deactivating the target system-related modules and transmitting a deactivation event report notifying that the target system-related modules have been deactivated to the source system if the target system-related modules are activated and the mobile terminal is not located in the dummy cell of the source system, which is co-located with the service area of the target system.

52. The method as claimed in claim 51, wherein if the intensity of a signal received from the dummy cell is below a target system threshold specified by an activation/deactivation control message, it is judged that the mobile terminal is not located in the dummy cell.

53. A method for performing hard handover between systems employing different wireless access technologies from each other, the method comprising the steps of:
performing handover between system controllers as a mobile terminal connects a call to a SRNC belonging to a source system and then moves to a DRNC belonging to the source system and neighboring a target system;
providing information about a border cell belonging to the DRNC and neighboring the target system, and information about a dummy cell, which belongs to the DRNC, neighbors the target system and transmits a downlink common channel signal of the target system, from the DRNC to the SRNC; and
controlling the mobile terminal's handover into the target system with reference to the information about the border and dummy cells by the DRNC.

54. The method as claimed in claim 53, wherein in the controlling step, the mobile terminal's the handover into the target system is performed if the mobile terminal is continually located in the border cell belonging to the DRNC during a predetermined time.

55. The method as claimed in claim 53, wherein in the controlling step, the mobile terminal's the handover into the target system is performed if the mobile terminal is located in the dummy cell belonging to the DRNC and the dummy cell is the best cell or the mobile terminal is continually located in the dummy cell during a predetermined time.
